(19) United States
(12) Patent Application Publication
(10) Pub. No.: US 2021/0259472 A1
(43) Pub. Date: Aug. 26, 2021

(54) A FOOD PROCESSING APPARATUS

(71) Applicant: KENWOOD LIMITED, Havant, Hampshire (GB)

(72) Inventors: Mark SEIDLER, Havant (GB); Andrew PALMER, Havant (GB); Matthew CALLAHAN, Havant (GB); Adam WESTWOOD, Havant (GB); Martin HUNT, Havant (GB)

(21) Appl. No.: 16/973,857

(22) PCT Filed: Jun. 28, 2019
(86) PCT No.: PCT/GB2019/051848

§ 371 Date: Dec. 10, 2020

(30) Foreign Application Priority Data
Jun. 29, 2018 (GB) 1810781.3
Oct. 8, 2018 (LU) LU100952

(51) Int. Cl. A47J 43/07; A47J 43/046; A47J 43/08; A47J 36/32; B26D 1/00

(52) U.S. Cl. CPC A47J 43/0772; A47J 43/046; A47J 43/085; B26D 2210/02; A47J 43/0727; B26D 1/0006; B26D 2001/0053; A47J 36/32

(57) ABSTRACT

A food processing apparatus comprises a container for food to be processed, the container having a removable cover arranged to engage with the container, and a tool drive for a processing tool, wherein the apparatus is arranged to operate in a first processing mode when the cover is engaged with the container, and is arranged to operate in a second processing mode when the cover is not engaged with the container, in which in the second processing mode, use of the tool drive for processing is restricted with respect to the first processing mode. Thus the apparatus can operate in a ‘safe’ mode when the lid is not engaged.

This invention relates to a food processing apparatus, in particular a food processor having a cover or lid. Such processors may be a multipurpose apparatus in which a plurality of interchangeable rotary food preparing tools are removably mounted on a tool drive for performing tasks involving cutting or stirring ingredients in a container in accordance with specific techniques, such as those involving heating and cooking process.

A food processing apparatus, for example a cooking processor, may have a container and a motor-driven tool drive, for example in the base of the container, on which a tool or various selected rotary tools may be mounted to be driven for performing various food processing tasks as desired by the user. Currently most such food processing apparatus will require a cover to be attached over the top of the container in order for the rotary food preparing tool to operate, for example by having a safety interlock. The benefit of cooking with an attached cover is that it creates a safe mode for the food processing apparatus to operate in. Without an attached cover it may be dangerous for the food processing apparatus to be able to operate with access to sharp parts such as a knife tool rotating in the container. Moreover there is also a risk of spilling food stuffs which may be hot on the user if the tool rotates without a cover on top, which may cause injury.

However there are several drawbacks of such food processing apparatus which can only operate with cover being attached. It may be difficult for dishes to reduce down and thicken because steam from the cooking process may collect as condensation on the inside of the cover and eventually drip back into the container. This means it can take longer to cook a dish. It can also be difficult for the user to see into the container once there is condensation on the cover. In addition, if the food is to not stirred when the cover is attached, it is possible that the container contents can burn without user interaction which is impeded by the lid. Manual stirring may be restricted by a tool which is already fitted to the food processor bowl.

This invention aims to address one or more of these issues.

The present invention provides a food processor apparatus as defined in the appended claims.

Thus the processor apparatus has a first processing mode when the cover is engaged with the container, and is arranged to operate in a second processing mode when the cover is not engaged with the container, in which in the second processing mode, use of the tool drive for processing is restricted with respect to the first processing mode.

In one example, the food processing apparatus, comprises: a base unit, a container for food to be processed, a removable cover arranged to engage with the container, and a tool drive for a processing tool, wherein the food processing apparatus may be arranged to be detachably mounted to the base unit and preferably, is arranged to receive drive from the base unit. The food processor may have one or more heating elements for heating the contents of the container. Preferably, the apparatus is arranged to operate in both cover on and cover off mode.

Preferably, there are two or more separate interlocks for the container and container cover. When the first interlock is engaged the food processing apparatus is restricted by the electronic control so that the tool can only turn at a slow speed. In one embodiment, the tool is unable to turn faster until the additional higher speed interlock(s) are engaged. At the desired low speed (preferably less than 80 RPM, more preferably less than 50 RPM, more preferably still less than 20 RPM), ingredients will not be ejected clear of the container (e.g., with 180 mm high side-walls). When the cover is attached to the container, a second or additional interlock is engaged allowing the motor to operate at higher speeds. At high speeds the cover can then capture or prevent any food stuffs being ejected clear of the container.

In other preferred embodiments of the invention, a food processing apparatus comprises: a base unit, a container for food to be processed, a removable cover arranged to engage with the container, a tool drive provided within the compartment for driving a tool for a processing tool and an electric motor which can turn in two directions such as, but not limited to, a BLDC (Brushless DC) or switched/synchronous reluctance motor, such that the direction can be the reverse of the normal direction of a sharp tool such as a knife tool.

In the first processing mode the cover is engaged with the container, and in a second processing mode when the cover is not engaged with the container, the direction of the tool drive is reversed so the sharp edge of the tool is trailing and the blunt edge is leading in the safest configuration. This type of food processor with ‘cover off cooking’ may be produced using a number of different motor types. For example, the apparatus could be fitted with two separate motors. One motor can be dedicated for cover off mode (slow speed), which is not able to run at the higher speeds. The second motor could be used for cover on operation and give the user the capability to access the full speed range of the container. Optionally the tool may be provided presenting a knife in one direction of travel and a different processing tool such as a stirring paddle in the other which could be used for stirring function in the second processing mode.

In an alternative embodiment, the construction of the lid can be divided into two parts, having a removable centre part and an outer part. Instead of using the container itself, the lid outer part may be arranged to active the ‘cover off cooking’ interlock that enable safe operation of the motor.

In another example or aspect, in order to prevent any user access to the container in ‘cover off’ mode, a wire lid, mesh or cage may be arranged to be fitted on top of the container. Furthermore, the openings can be sized to prevent a user touching any moving parts. Optionally the cage may be constructed in wire, sheet metal or injection moulded polymer.

In certain arrangements, the apparatus uses a single motor and drive technology therefore. Where it is not practical to turn the cutting tools such as a knife tool backwards, a knife tool adaptor can be used to prevent the knife tool from running when the cover is not engaged on the container. The knife adaptor must be fitted in place in order for the user to operate the knife tool. Particularly, the adaptor may have a drive feature on the top of the shaft. The knife tool then can fit over the adaptor and also has a drive feature on the top. In cover off mode, if the food processing apparatus is to be run, the knife adaptor can prevent the knife tool from operating by simply turning inside the knife tool. In cover on mode, a separate coupling in the cover can allow the tool to rotate with the knife adaptor.

In a further example for the food processing apparatus with a single direction motor and drive, a clutch system can be used to prevent the knife being able to function and force the user to fit an alternative tool. When the knife tool is fitted to a container and cover is not in place, the spring can raise the tool coupling clear of the container drive coupling. This means for a knife tool, when the food processing apparatus is set to slow speed stir, the coupling can simply rotate inside tool and not cause the knife tool to rotate. However stirring tools or other tools which do not present a hazard can connect directly to the drive coupling when attached even without the rover being present. When the cover is fitted, the plunger on top of the knife tool is pushed down by the cover which can cause the drive couplings to join and allow the knife tool to rotate. When the cover is removed at any point, the spring inside the tool can cause the coupling in the knife tool to be raised clear of the drive coupling in the container.

An additional variation on this concept can use the arrangement of a gear box with a sprung clutch to reduce the speed of motor to a safe limit when the cover is off. For example, a one way sprung clutch added to the drive system of the apparatus can remove the danger of the container tool turning too fast. When the cover is not attached, the apparatus can use an interlock system to detect the activation of cover off mode so that the motor can turn in one direction which can also utilise the reduction of a gearbox or belt to restrict the possible speed of the tool. When the cover is attached, the interlock may allow the motor to turn in the opposite direction and utilise the closer ratio and therefore achieve a higher speed.

In an addition embodiment, a solenoid operated clutch may be arranged to restrict the speed of the motor in cover off mode, by allowing the motor to change between two gears with higher ratio and lower ratio separately. When the cover interlock activates cover off mode, the solenoid operated clutch can select the higher ratio therefore reducing the danger of the tool turning at an unsafe speed. The solenoid operated clutch can only be activated to allow faster speed when the cover interlock is engaged by selecting the slower ratio.

The invention extends to a food processing apparatus which may comprise a separate low speed cooking container with a dedicated interlock which can prevent the user running the product at a higher speed.

Preferably, the food processing apparatus comprises a plurality of removable tools for engagement with the tool drive.

According to another aspect of the present disclosure, there is disclosed a food processing apparatus, optionally as aforesaid, comprising a plurality of removable tools for engagement with the tool drive disclosed herein.

According to another aspect of the present disclosure, there is disclosed a processing tool for a food processing apparatus, the tool comprising an engagement arrangement for engaging a tool drive of the apparatus so as to allow driving of the tool, the engagement arrangement having a first position corresponding to engagement of the drive and a second position corresponding to disengagement of the drive, the engagement arrangement is biased into the second position.

Preferably, the tool is arranged for use in a food processing assembly as disclosed herein.

Preferably, the tool is arranged to be used with a second tool, where the second tool is arranged to operate in a first processing mode when the cover is engaged with the container, and in a second processing mode when the cover is not engaged with the container, in which in the second processing mode use of the tool is restricted with respect to the first processing mode. Optionally, the tool and the second tool are part of a combined tool.

According to another aspect of the present disclosure, there is disclosed a processing tool for a food processing apparatus, the tool having at least one processing blade, the tool being arranged to present at least one cutting edge when the tool is operated in a first direction and arranged to present a different processing edge when operated in a second direction, and not to present a cutting edge when operated in the second direction.

Preferably, the tool is arranged for use in a food processing assembly as disclosed herein.

Preferably, the tool is arranged to be used in an apparatus comprising: a container for food to be processed, the container having a removable cover arranged to engage with the container, and a tool drive for a processing tool. Preferably, the tool is arranged to operate in a first processing mode when the cover is engaged with the container, and in a second processing mode when the cover is not engaged with the container, in which in the second processing mode, use of the tool is restricted with respect to the first processing mode.

Optionally, use of the tool is restricted by restricting use of the tool drive. Optionally use of the tool is restricted by limiting the speed of the tool drive. Optionally use of the tool is restricted by reversing the direction of operation of the tool drive and/or the tool.

According to another aspect of the present disclosure, there is disclosed a food processing apparatus, optionally as aforesaid, comprising: a container for food to be processed, the container having a removable cover arranged to engage with the container, and a tool drive for a processing tool, wherein the cover comprises a plurality of apertures arranged to impede access to the container during processing.

There is also disclosed a food processing apparatus, optionally as aforesaid, being arranged to operate in a first processing mode or a second processing mode dependent upon the identity of a container mounted to the apparatus.

Preferably, use of a tool drive of the food processing apparatus is restricted in the second processing mode with respect to the first processing mode. The first processing mode and second processing mode may have any of the characteristics of processing modes disclosed herein.

As used herein, the term “processing” preferably connotes any action relating to or contributing towards transforming products into foodstuff, or transforming foodstuff into a different form of foodstuff, including—as examples—applying mechanical work (e.g. for cutting, beating, blending, whisking, dicing, spiralising, grinding, extruding, shaping, kneading etc.) and applying heat or cold. “Food” and “foodstuff” as used herein can include beverages and frozen material and material used in creating them (e.g., coffee beans).

As used herein, the term “tool” preferably connotes tools for processing food ingredients, for example cutting, slicing, dicing, shredding, stirring, chopping, for example. A “cutting disc” is an example of such a tool.

Any apparatus feature as described herein may also be provided as a method feature, and vice versa. As used herein, means plus function features may be expressed alternatively in terms of their corresponding structure. The invention extends to methods, system and apparatus substantially as herein described and/or as illustrated with reference to the accompanying figures.

The invention also provides a computer program or a computer program product for carrying out any of the methods described herein, and/or for embodying any of the apparatus features described herein, and a computer readable medium having stored thereon a program for carrying out any of the methods described herein and/or for embodying any of the apparatus features described herein.

The invention also provides a signal embodying a computer program or a computer program product for carrying out any of the methods described herein, and/or for embodying any of the apparatus features described herein, a method of transmitting such a signal, and a computer product having an operating system which supports a computer program for carrying out the methods described herein and/or for embodying any of the apparatus features described herein.

Furthermore, features implanted in hardware may generally be implemented in software, and vice versa. Any reference to software and hardware features herein should be construed accordingly. Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

### DETAILED DESCRIPTION OF THE DRAWINGS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The invention will now be described, by way of example, with reference to the following drawings, in which:

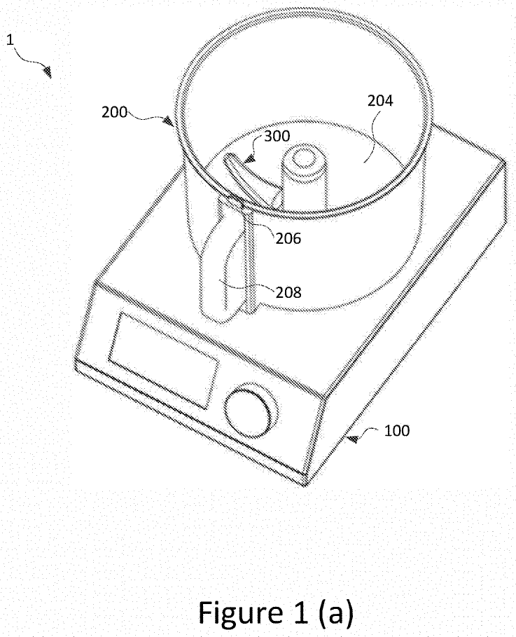

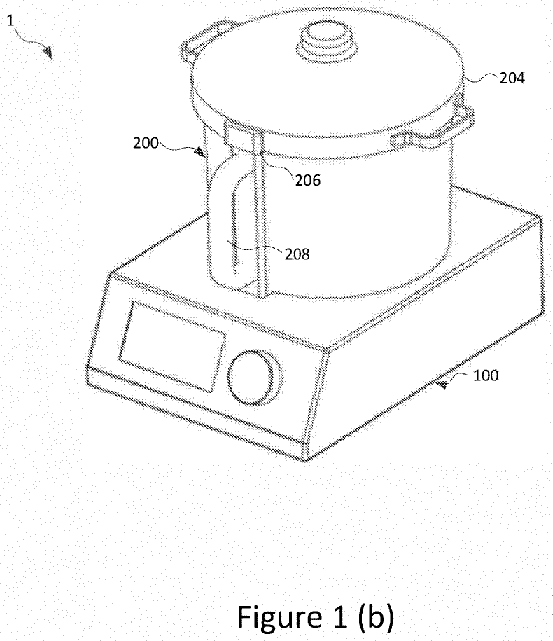

FIG. 1(a) is a perspective view of a food processing apparatus;

FIG. 1(b) shows the food processing apparatus of FIG. 1(a) with a cover engaged;

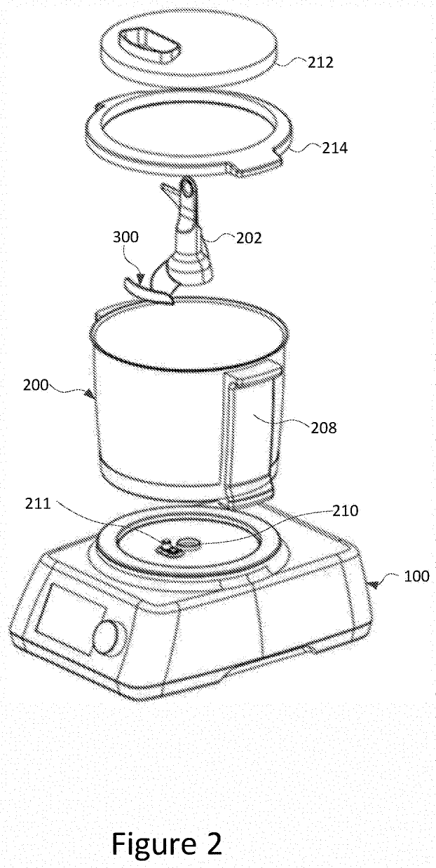

FIG. 2 shows an exploded view of the food processing apparatus;

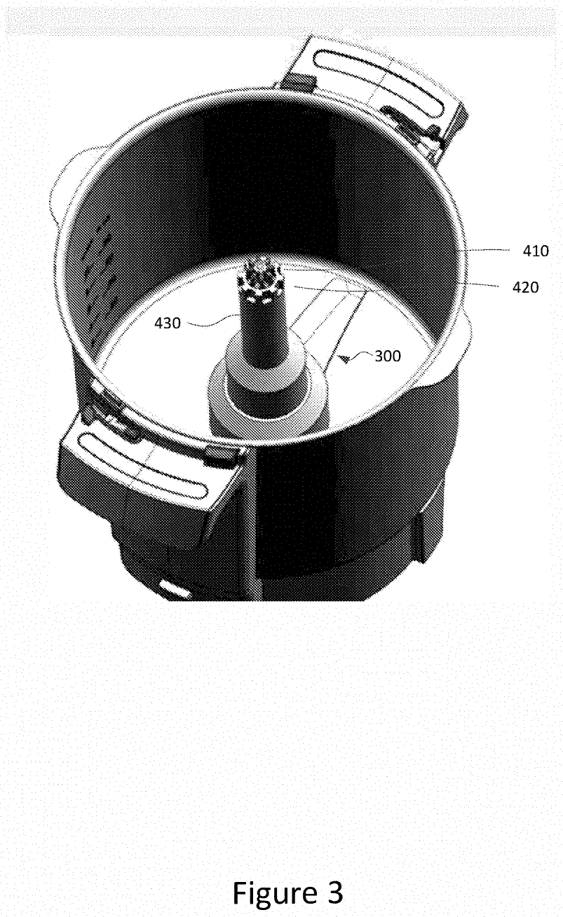

FIG. 3 is a perspective view from above of the interior of the bowl of a food processing apparatus;

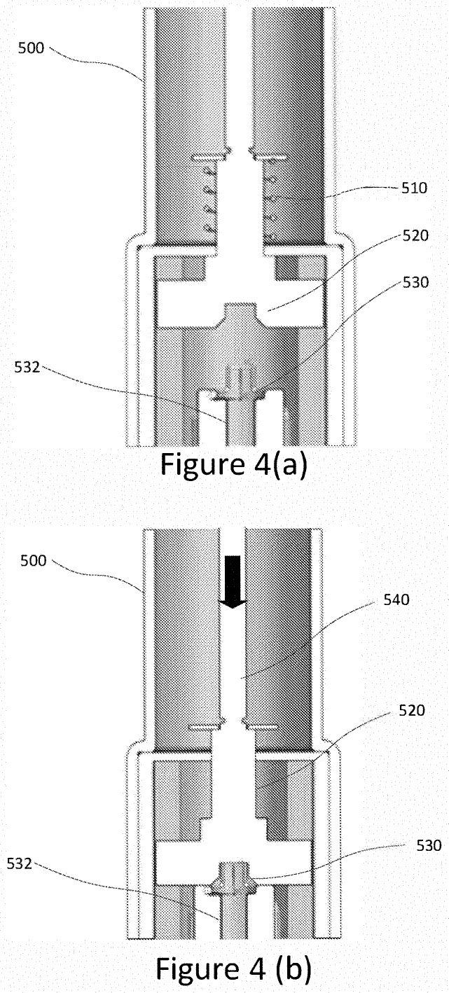

FIGS. 4(a) and 4(b) are cross-sectional side views of part of a tool drive of a processing apparatus;

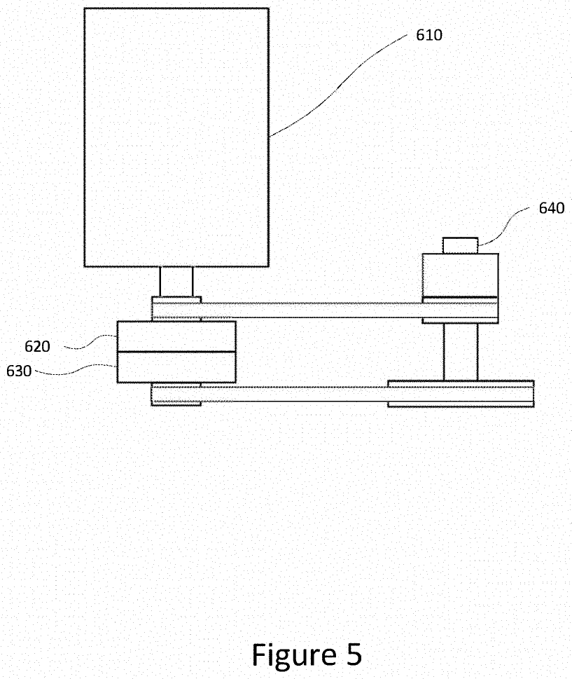

FIG. 5 shows a clutch system of a food processing apparatus;

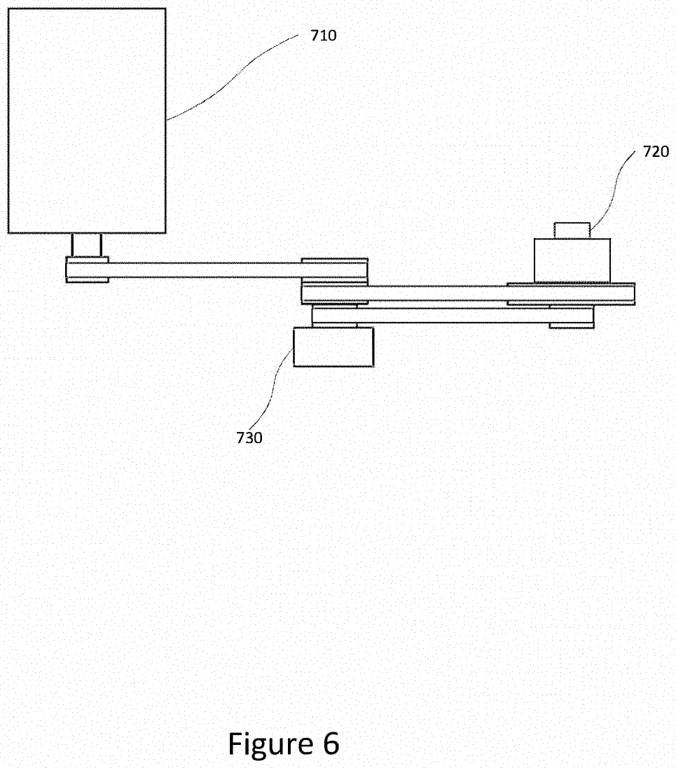

FIG. 6 shows another clutch system of a food processing apparatus;

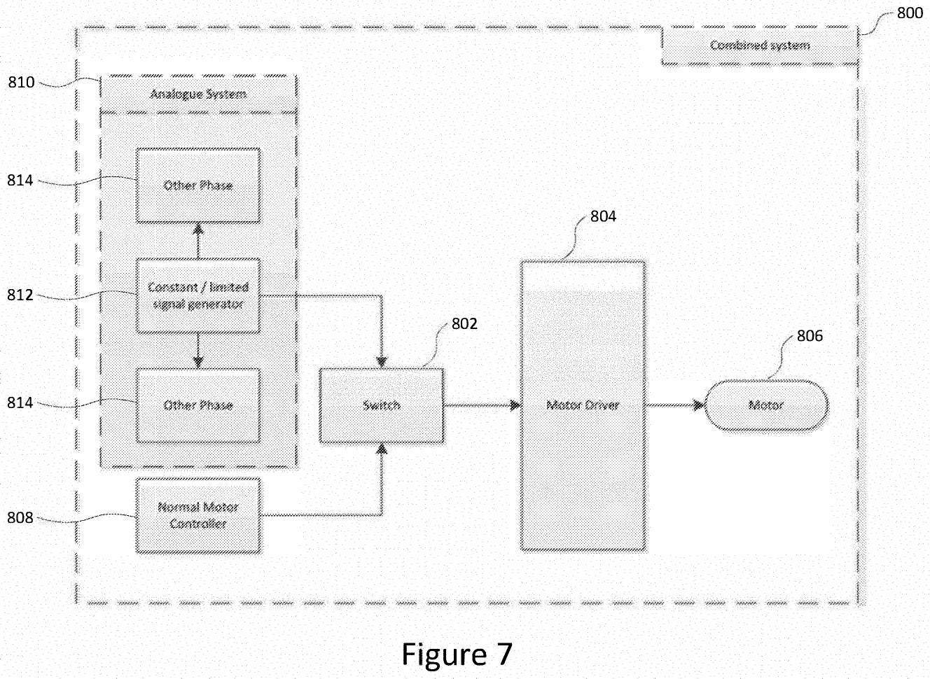

FIG. 7 is a diagram of a control system of a food processing apparatus;

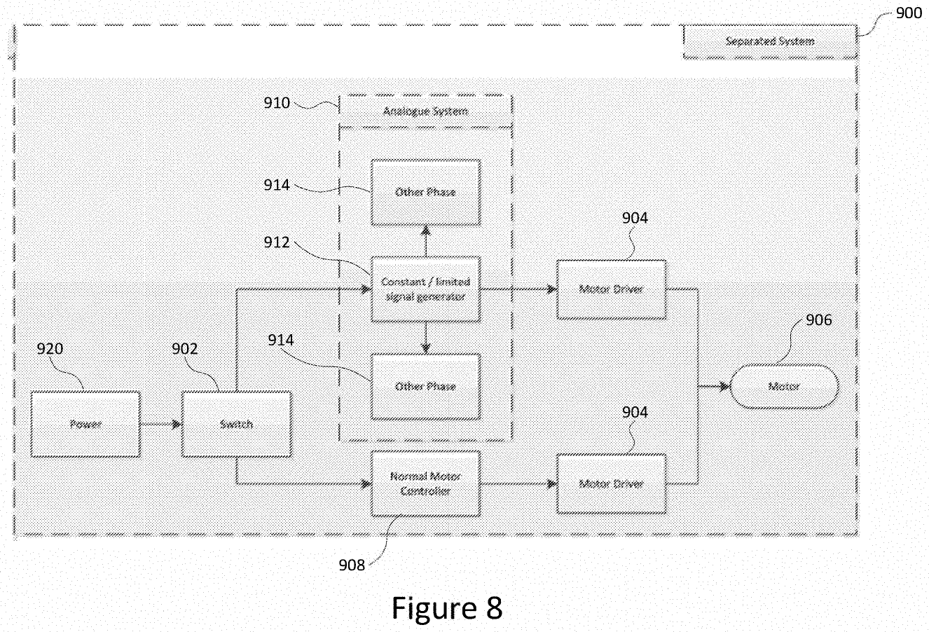

FIG. 8 shows another control system of the food processing apparatus;

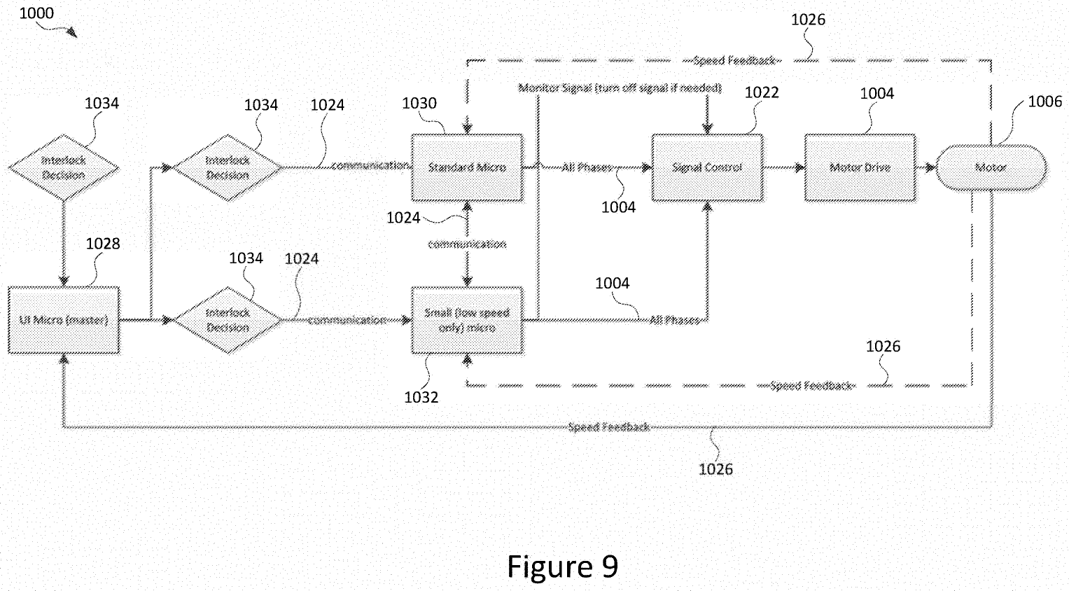

FIG. 9 shows a digital brushless control system of the food processing apparatus;

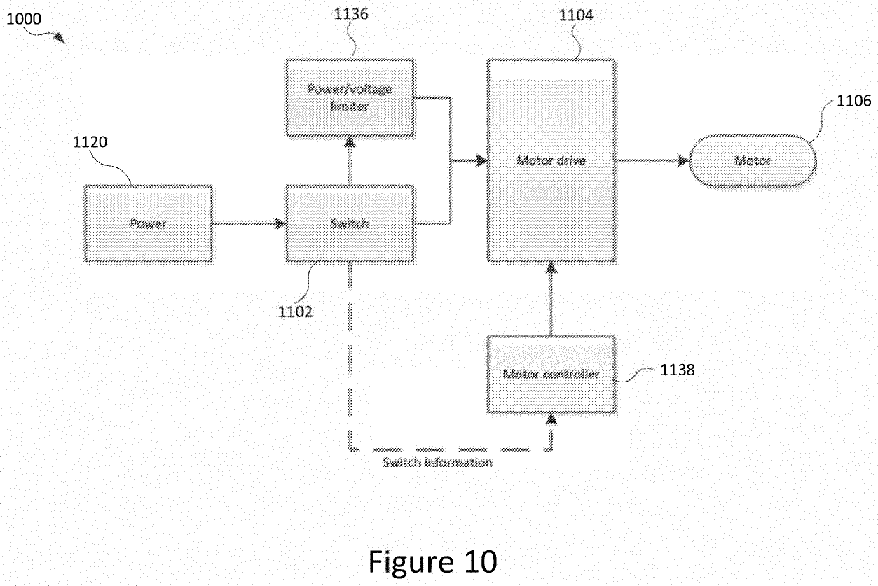

FIG. 10 shows a universal control system of the food processing apparatus.

FIGS. 1(a) and 1(b) shows a food processing apparatus according to an exemplary embodiment of the present invention. The food processing apparatus 1 comprises a base unit 100, a container 200, a food processing tool 300 and a removable cover 204. The container 200 and tool 300 are arranged to be capable of being detached from the base unit 100. The processor includes two or more interlocks for activating first and second processing modes respectively. These may be a container interlock for the container 200 and the base unit 100, and a cover interlock for the cover 204 and the container 200.

The processor 1 has a rotatable tool drive coupling 210 typically in the form of a drive shaft which extends into the container 200 from the base 204 and carries a tool 300. The container 200 is also provided with a removable cover 204 with a container cover interlock member 206 extending adjacent the top of the container 200. The container has a handle 208 on one side thereof, and the cover interlock member 206 may extend at one end of the handle 208. Means for heating the contents of the container 200, such as one or more heating elements (not shown) may be provided, for example in the base unit 100 or in the container 200, for cooking purposes. The container 200 in this example has a circular cross-sectional shape.

When the container or bowl 200 is fitted to the base 100, a first or container interlock, as known in the art, is activated. For example, the first interlock may be activated by interaction between the bowl handle and the base, with the interlock optionally being located in base unit, for example being are element 211 which is actuated when the bowl is mounted on the base (see FIG. 2). The processor is then able to operate in a second, or ‘lid off’ processing mode, which restricts operation. When the cover 204 is also fitted to the container 200, a second or cover interlock is activated, whereby the processor is able to operate in a first processing mode, where normal operation is possible.

In one example, when the bowl 200 is fitted and the first interlock is activated, the speed of operation is limited to a safe slow speed, at which ingredients are unlikely to be ejected clear of the bowl (which for example has side-walls about 180 mm high). When the bowl interlock is engaged the processor or machine is restricted, for example by an electronic control, the machine can only turn at a slow speed. The machine is unable to turn faster until additional higher speed interlock or interlocks are engaged by engaging the cover with the container, as described below.

Alternatively or in addition, the processor may comprise an electric motor which can turn in two directions (such as but not limited to a BLDC (Brushless DC) or switched/synchronous reluctance motor), and the direction may be the reverse of the forward or normal direction in the second mode, such that the sharp edge of a tool such as a knife tool is trailing and the blunt edge is leading, creating a safer operation when the lid is off.

When the cover 204 is attached to the container 200, and the second interlock 206 (eg on the container handle 208) is engaged, the processor may operate in the first mode, such that the motor and thus the tool 300 via the drive coupling can turn at higher speeds. At these speeds, the cover 204 can then capture or prevent any food stuffs being ejected clear of the container. Alternatively or in addition, the tool drive may rotate in the forward operating direction for normal processing.

The processor could be fitted with two separate motors, one motor being dedicated for ‘lid off’ mode (slow speed), which would not be able to run at the higher speeds. The second motor could be used for ‘lid on’ operation giving the user the capability to access the full speed range of the processor.

Typically, in each mode, the tool 300 is coupled to at least one motor via the drive coupling, so that in each mode the tool 300 is capable of receiving a drive power that causes a rotation of the tool 300. In the ‘lid off’ mode, it remains possible to provide power to the tool drive—that is the user is able to operate the tool drive when the cover 204 is not attached—however, the operation of the tool drive, and the drive power received by the tool 300, is restricted, or reduced, in the ‘lid off’ mode as compared to the ‘lid on’ mode.

Since in each mode the tool 300 remains coupled to at least one motor via the drive coupling, in both of the first and the second mode the tool drive and the tool 300 are operable and controllable by a user of the apparatus. The use of the tool 300 is, however, restricted in the second mode. In other words, both of the ‘lid on’ mode and the ‘lid off’ are processing modes, where the tool drive is controllable so that the tool 300 can be used for processing contents of the container 200.

FIG. 2 shows an exploded view of a food processing apparatus. In this embodiment, the construction of the lid comprises two parts: a centre part or lid inner 212 and lid outer 214. The lid inner 212 is a removable cover, with the lid outer 214 able to remain in place on the container 200. In this embodiment, the lid outer 214, by engaging with the bowl, can trigger a first interlock to activate the second mode for lid off operation. The lid inner 212, by engaging with the lid outer 214, can trigger a second interlock to allow the first mode for lid on operation.

To prevent any user access to the bowl in ‘lid off’ mode a modified cover with a plurality of small apertures, such as a wire lid or cage, may be fitted on top of the bowl. The openings on this modified cover could be sized such it would be unlikely or impossible for a user to touch any moving parts. The cage could be constructed in wire, sheet metal or injection moulded polymer.

For ‘lid off cooking’ a number of different motor types could be used. Using a motor capable of two directions would allow the processor to stir backwards, so if a sharp tool such as a knife tool is fitted to the processor it would rotate in a safer manner. For example, a tool may be provided presenting a knife in one direction of travel and a stirring paddle in the other.

However, where the motor is only capable of turning in one direction, it may not be possible safely to use a knife tool in lid off mode.

FIG. 3 shows a knife tool adaptor of the food processing apparatus which is used to restrict or prevent a knife or other bladed tool from operating in the lid off mode, for example where the apparatus is not able to turn in two directions. In order to use the knife tool 300 in this embodiment, an adaptor must be fitted in the apparatus, for example to the drive coupling. The adaptor has a drive feature 410 which is on the top of the drive shaft when the adaptor is fitted thereto. The knife tool 300 can be fitted over the adaptor, and also has a drive feature 420 at the end or top of the tool shaft 430. If the food processing apparatus is to run without the cover 204 attached, the adaptor 430 is not engaged with the tool, and thus may simply turn with the drive shaft inside the knife tool 300. Once the cover 204 is attached, an engagement or separate coupling in the cover may the tool to rotate with the adaptor 430, for example by causing engagement of the adaptor with the tool.

FIGS. 4(a) and 4(b) show an example of a clutch system for a tool such as knife tool so that it is unable to operate with the lid off. The clutch system can be used to restrict operation by preventing certain tools such as a knife tool being able to function in lid off mode, such that the user would have to fit an alternative tool.

When the knife tool 500 is fitted to a container and cover is not in place (FIG. 4(a)), the spring 510 can raise the tool coupling 520 clear of the container drive coupling 530. If the food processing apparatus is set to slow speed stir, the coupling can simply rotate inside the tool and not cause the tool to rotate. However, selected tools such as stirring tools (for example a stirring paddle) can be arranged to connect directly to the drive coupling when attached, and may therefore operate without the cover being present.

FIG. 4(b) shows the lid on mode of the clutch system for the restriction of use of the knife tool. When the cover is attached, a plunger 540 can be pushed down by interaction with the cover, which causes the drive couplings 520, 530 to join and allow the tool 500 to rotate. If the cover is removed, the spring 510 inside the tool 500 will cause the coupling 520 in the tool 500 to be raised clear of the drive coupling 530 in the container.

As an alternative to this, the tool itself could have a gear box with a sprung clutch to reduce the speed to a safe limit when the lid is off.

Referring to FIG. 5, a one way sprung clutch system of the food processing apparatus could be used to restrict the speed of the tool. This arrangement comprises a reversible motor 610, a right hand one way sprung clutch 630, a left hand one way sprung clutch 620, and concentric drive 640 rotating inner and outer couplings. When in cover off mode, for example with the food processing apparatus detects the cover is off using interlocks as described above, the motor 610 can turn in one direction and can also utilise the reduction of a gearbox or belt to restrict the possible speed of the tool. When the cover is attached the interlock can activate lid on mode and allow the motor to turn in the opposite direction whilst also utilising the closer gear ratio and therefore achieving a higher speed.

FIG. 6 shows another example of gear box system using solenoid operated clutch, which allows the food processing apparatus to change between two gears and therefore restrict the speed of the motor in cover off mode. This system comprises a reversible motor 710, solenoid operated clutch 730 and a concentric drive 720 for rotating inner and outer couplings. When the interlocks activate cover off mode the solenoid operated clutch can select the higher ratio therefore reducing the danger of the tool turning at an unsafe speed in cover off mode. The solenoid operated clutch can only be activated to allow faster speed when the cover interlock is engaged to activate the lid on mode.

In an alternative embodiment, a separate low speed cooking bowl with a dedicated interlock could be used to prevent the user running the product at a higher speed.

FIG. 7 shows a combined control system 800 of the food processing apparatus, being a brushed or brushless system. In this embodiment, the ‘Switch’ 802 is a means to redirect the drive signal from one place to another, which could be a mechanical switch or a solid state switch or a combination of both. The switch is connected to a ‘Motor driver’ 804, being a device or circuit used to drive the motor 806, including but not limited to IGBT, MOSFET, TRIAC. An analogue system 810 comprises a ‘constant/limited signal generator’ 812, which is a circuit that by design can only generate one or a range up to a low limit of signals which is required to drive the motor such as but not limited to, sine wave, square wave, pulsed square wave etc. There may also be at least one ‘other phase’ 814 in the case where the motor type requires more than one phase to drive it. It can be defined as a circuit that takes the source to be the ‘constant/limited signal generator’ and outputs the same base signal but out of phase (and if required by the motor type, a lower/high voltage). All of these signals will be passed through the switch to feed the motor.

In a combined system, the ‘normal motor controller’ 808 is commonly a microcontroller but could also be an analogue circuit, which generates the signals needed to turn the motor at the requested speed. When the switch is activated, it redirects the signal from the ‘normal motor controller’ to the analogue system therefore allowing the analogue system to drive the motor using the same motor drive components.

FIG. 8 shows a separated control system 900 of the food processing apparatus, which may be brushed or brushless. In FIG. 8, corresponding reference numerals are used to denote components that are also shown in FIG. 7. In this embodiment, ‘Power’ 920 is defined as the source of power for the motor (eg mains input). The operation of the separated system is the same as the combined system except that separated motor drivers 904 are used (which could be the same as or different from each other). This means that only one system is in operation at one time, and therefore one cannot influence control over the other.

FIG. 9 shows a digital brushless control system 1000 of the food processing apparatus. In FIG. 9, corresponding reference numerals are used to denote components that are also shown in FIGS. 7 and 8. In this embodiment, ‘Motor drive’ 1004 is the device or circuit used to drive the motor 1006, including but not limited to IGBT, MOSFET, TRIAC. ‘Signal control’ 1022 is a method to redirect the drive signal from one place to another, e.g. this could be a mechanical switch or a solid state switch or a combination of both. ‘Communication’ 1024 is some exchange of data between 2 or more devices. This includes but not limited to UART, SPI, I2C, Parallel, Wireless etc. ‘Speed feedback’ 1026 can be a physical sensor or a senseless or a combination and includes but not limited to Hall effect sensor, coil sensor, encoder, Detecting motor current feedback etc.

The digital brushless control system comprises a UI Micro 1028 (acting as a master), a standard micro 1030, and a small (low speed only) micro 1032. Interlock decisions 1034 may be communicated from the UI Master to the standard micro and/or small micro. Interlock decisions may also be communicated to the UI Micro. In this process, the demand speed is generated from the UI Micro 1028. However it could also be generated locally in a system where there is no UI Micro. In all communications individual interlock states are communicated to ensure safe operation. If the interlock states do not match up, operation may be stopped in multiple locations. When not operating the motor, the other micro(s) check the speed (and/or power) of the motor to ensure correct and safe operation. ‘All phases’ 1036 may be just be one phase in the case where the motor type only requires one phase.

FIG. 10 shows a universal control system 1100, which may be lower cost, of the food processing apparatus. In FIG. 10, corresponding reference numerals are used to denote components that are also shown in FIGS. 7 and 8. In this embodiment, ‘Power’ 1120 is the source of power for the motor (eg mains input). ‘Switch’ 1102 is a method to redirect power from one place to another, e.g. this could be a mechanical switch or a solid state switch or a combination of both. ‘Power/voltage limiter’ 1136 is a circuit which reduces the power or voltage available; in the case of a universal motor this could be a simple diode or a transformer etc. ‘Motor drive’ 1104 is the device or circuit used to drive the motor, including but not limited to IGBT, MOSFET, TRIAC.

The motor controller 1138 is preferably a microcontroller but could also be an analogue circuit, which generates the signals needed to turn the motor at the requested speed. When the switch is activated it redirects the power through the limiter and the motor control is made aware of this action either directly from the switch (or switch pair) or indirectly via measuring the available power to the motor. This limiting of the power makes it impossible for the motor to turn at high speeds and is controlled further by the motor controller.

The invention described here may be used in any kitchen appliance and/or as a stand-alone device. This includes any domestic food-processing and/or preparation machine, including both top-driven machines (e.g., stand-mixers) and bottom-driven machines (e.g., food processors). It may be implemented in heated and/or cooled machines. The invention may also be implemented in both hand-held (e.g., hand blenders) and table-top (e.g., blenders) machines. It may be used in a machine that is built-in to a work-top or work surface, or in a stand-alone device. The invention can also be provided as a stand-alone device, whether motor-driven or manually powered.

Whilst the invention has been described in the field of domestic food processing and preparation machines, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilisers, grain and other agricultural and/or veterinary products; oils; fuels; dyes; cosmetics; plastics; tars; finishes; waxes; varnishes; beverages; medical and/or biological research materials; solders; alloys; effluent; and/or other substances.

Certain aspects of the invention disclosed herein may also find application in automotive and industrial fields, the field of tools including hand-tools, the field of plumbing, and the field of hydraulics, for example.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1. A food processing apparatus comprising:
a container for food to be processed, the container having a removable cover arranged to engage with the container, and
a tool drive for a processing tool,
wherein the apparatus is arranged to operate in a first processing mode when the cover is engaged with the container, and is arranged to operate in a second processing mode when the cover is not engaged with the container, in which in the second processing mode, use of the tool drive for processing is restricted with respect to the first processing mode.

2. The food processing apparatus according to claim Error! Reference source not found., wherein in the second processing mode, with respect to the first processing mode:
the speed of the tool drive is restricted.

3. The food processing apparatus according to claim 2, wherein in the second processing mode, with respect to the first processing mode:
the maximum speed of the tool drive is limited to less than 80 RPM, preferably less than 50 RPM, and more preferably less than 20 RPM.

4. The food processing apparatus according to claim Error! Reference source not found., wherein in the second processing mode, with respect to the first processing mode:
the direction of the tool drive is changed, preferably reversed.

5. The food processing apparatus according to claim 4, comprising a motor adapted to turn in one direction in the first processing mode and in a reverse direction in the second processing mode.

6. The food processing apparatus according to claim 1, comprising at least two motors adapted for use in the first and second processing mode respectively.

7. The food processing apparatus according to claim 1, wherein the removable cover comprises at least a part of a lid of the container, optionally an inner part of a lid, and/or wherein the removable cover comprises a plurality of apertures, preferably in the form of a mesh, optionally formed of wire, sheet metal or injection moulded polymer.

8. (canceled)

9. The food processing apparatus according to claim 1, wherein in the second processing mode, with respect to the first processing mode, engagement of a processing tool with the tool drive is impeded, preferably comprising a tool adaptor arranged to facilitate engagement between a tool and the tool drive in the first processing mode, and to impede engagement in the second processing mode.

10. (canceled)

11. The food processing apparatus according to claim 8, wherein the cover is arranged to engage with the tool, directly or indirectly, in the second processing mode, and/or comprising a clutch system adapted to impede the drive coupling of the processing tool in the second processing mode.

12. (canceled)

13. The food processing apparatus according to claim 1, comprising gearing arranged to limit the speed and/or the direction of the tool drive in the second processing mode, with respect to the first processing mode, preferably comprising a gear box system having a sprung clutch or Solenoid operated clutch.

14. The food processing apparatus according to claim 1, comprising a cover interlock between the cover and the container for activating the first processing mode, and optionally comprising a container interlock arranged to indicate that the container is engaged with apparatus.

15. The food processing apparatus according to claim 1, wherein the apparatus is arranged to operate in the second processing mode when the container is engaged with the apparatus, preferably with a base of the apparatus.

16. The food processing apparatus according to claim 1, comprising a controller arranged to control the apparatus in dependence upon whether the cover, and optionally the container, are engaged.

17. The food processing apparatus according to claim 13, comprising a control system arranged to control the tool drive, and comprising:
a power source arranged to provide power to at least one motor;
at least one motor driver for driving the motor(s) selectively in the first or second mode; and
a switch for providing an input to the motor driver(s) for selecting the first or second mode.

18. The food processing apparatus according to claim 14, wherein the signal controller is a mechanical switch or a solid state switch or a combination of both, and/or wherein the or each motor controller is microcontroller or analogue circuit.

19. The food processing apparatus according to claim 1, comprising a heating arrangement for heating the contents of the container, and/or comprising a plurality of removable tools for engagement with the tool drive.

20. (canceled)

21. A processing tool for a food processing apparatus, the tool comprising an engagement arrangement for engaging a tool drive of the apparatus so as to allow driving of the tool, the engagement arrangement having a first position corresponding to engagement of the drive and a second position corresponding to disengagement of the drive, the engagement arrangement being biased into the second position.

22. A processing tool for a food processing apparatus, the tool having at least one processing blade, the tool being arranged to present at least one cutting edge when the tool is operated in a first direction, and being arranged to present a different processing edge when operated in a second direction, and not to present a cutting edge.

23. A food processing apparatus comprising: a container for food to be processed, the container having a removable cover arranged to engage with the container, and a tool drive for a processing tool, wherein the cover comprises a plurality of apertures arranged to impede access to the container during processing.

24. A food processing apparatus being arranged to operate in a first processing mode or a second processing mode dependent upon the identity of a container mounted to the apparatus.
